(19) United States
(12) Patent Application Publication
(10) Pub. No.: US 2009/0172015 A1
(43) Pub. Date: Jul. 2, 2009

(54) APPARATUS AND METHOD FOR PLAYING MAPPED OBJECTS

(75) Inventor: HUNG-CHI HUANG, Taichung City (TW)

Correspondence Address: WPAT, PC, 7225 BEVERLY ST., ANNANDALE, VA, 22003, US

(73) Assignee: MSTAR SEMICONDUCTOR, INC., HSINCHU HSIEN (TW)

(21) Appl. No.: 12/338,140

(22) Filed: Dec. 18, 2008

(30) Foreign Application Priority Data
Jan. 2, 2008 (TW) 097100022

(51) Int. Cl. G06F 17/30

(52) U.S. Cl. 707/103 R; 707/E17.055

(57) ABSTRACT

An apparatus for playing mapped objects and a method thereof are provided. When a first object is selected to be played, the apparatus for playing mapped objects and the method thereof according to the invention select a target object of a corresponding category from an object categorizing database, and prompt the first object and the target object to be played simultaneously by means of using an object playing unit, thereby accomplishing an effect of playing a plurality of multimedia objects of the same category at the same time.

### CROSS REFERENCE TO RELATED PATENT APPLICATION

This patent application is based on a Taiwan, R.O.C. patent application No. 097100022 filed on Jan. 2, 2008.

### BACKGROUND OF THE INVENTION

1. Field of the invention

The present invention relates to an apparatus for playing mapped objects and the method thereof, and more particularly, to an apparatus and its corresponding method for selecting a target object from a corresponding database and simultaneously playing a plurality of multimedia objects of the same category when an object is selected to be played.

2. Description of the Related Art

Many multimedia playing apparatuses, such as computers, cellular phones, DVD players, TVs, and gaming machines, are capable of playing multimedia objects or files such as pictures, music, and videos. However, among all the multimedia playing apparatuses, regardless of the kind of multimedia or files to be played, only a single multimedia object or file can be selected to be played. For example, at a certain time spot, only certain pictures, music, videos, music-incorporating pictures, or video-incorporating music, can be played. However, in any of the above cases, only one file is played at a time; more specifically, when the pictures or videos are browsed by the user, he cannot be given other choices—but listens to the music pre-edited jointly with the pictures or the videos.

Therefore, there exists a solid demand as suggested by the present invention, such as an apparatus for playing mapped objects; that is, when a first object is selected to be played, the apparatus automatically selects a corresponding target object and simultaneously plays the first object and the target object. Therefore, a plurality of multimedia objects of the same classification are played at the same time.

### SUMMARY OF THE INVENTION

In view of the disadvantages of the prior art, in which only a single multimedia object or file can be played at a time, the primary object of the present invention is to provide an apparatus of playing mapped objects and a method thereof.

According to one aspect of the present invention, an apparatus for playing mapped objects disclosed in the present invention comprises: an object database, having at least a first object (e.g., a current object) and a target object; a categorizing unit, coupled to the object database, for categorizing the first object according to at least one categorization rule and generating an object categorizing file; an object categorizing database, coupled to the categorizing unit, for storing the object categorizing file; an object playing unit, for playing the first object; and an object selecting unit, coupled to the object playing unit, the object database and the object categorizing database, for selecting the target object from the object database according to the first object currently played by the object playing unit and object category file. Wherein, the object playing unit simultaneously plays the target object and the first object.

According to another aspect of the present invention, an apparatus for playing mapped objects disclosed comprises: an object database, having at least a first object (e.g., a source object) and a target object; a user behavior database, for storing an object selecting record; a categorizing unit, coupled to the user behavior database, for generating an object categorizing file according to the object selecting record; an object categorizing database, coupled to the categorizing unit, for storing the object categorizing file; an object playing unit, for playing the first object; and an object selecting unit, coupled to the object playing unit, the object database and the object categorizing database, for selecting the target object from the object database according to the first object currently played by the object playing unit and the object categorizing file. Wherein, the object playing unit simultaneously plays the target object and the first object.

According to another aspect of the present invention, a method for playing mapped objects comprises steps of: playing a first object (e.g., a source object), selecting a target object from an object database according to the first object and an object categorizing file, and simultaneously playing the target object and the first object.

Whereby, when the first object (e.g., the source object) is selected to be played, a corresponding target object is selected from the object categorizing database. The first object and the target object are prompt to be played simultaneously such that a plurality of multimedia objects of the same category can be played simultaneously.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more readily apparent from the detailed description given herein below and the accompanying drawings which are given by way of illustration only, and thus are not limitative of the present invention and wherein:

FIG. 1 relates to a system block diagram of an apparatus for playing mapped objects according to one preferred embodiment of the present invention; and

FIG. 2 relates to a flow chart of a method for playing mapped objects according to the present invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

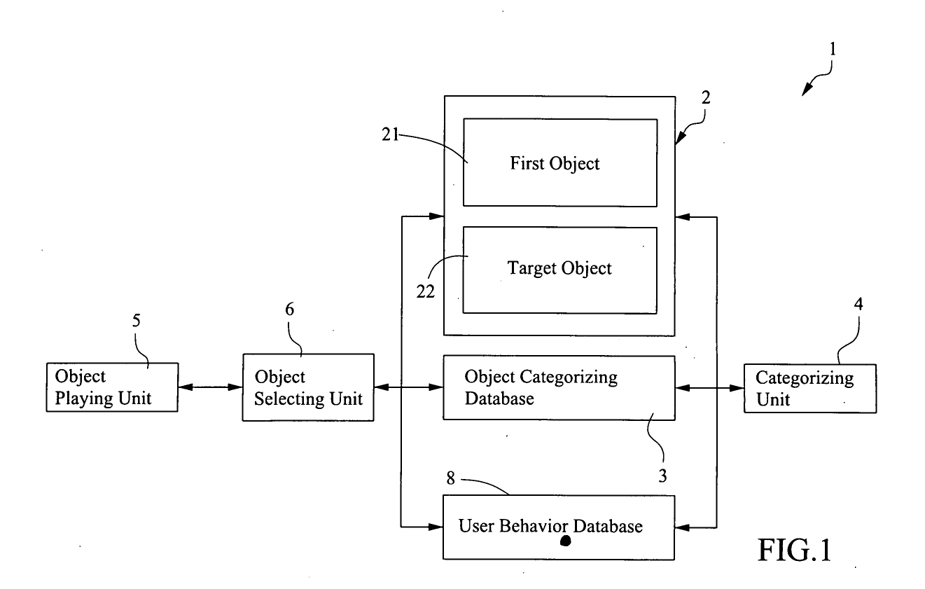

FIG. 1 relates to a system block diagram of an apparatus for playing mapped objects according to a preferred embodiment of the invention. An apparatus 1, for example, a multimedia player, computer, cellular phone, DVD player, TV, or gaming machine, for playing mapped objects, comprises: an object database 2, an object categorizing database 3, a categorizing unit 4, an object playing unit 5, an object selecting unit 6, and a user behavior database 8. The object database 2 has at least a first object 21 and a target object 22. The first object 21 and the target object 22 may be music, photos, videos, and multimedia files but not limited thereto. The categorizing unit 4 is coupled to the object database 2, and is for categorizing the first object 21 according to a categorization rule and generating an object categorizing file. The categorization rule is based on a file name or an established time of the first object 21. The object categorizing database 3 is coupled to the categorizing unit 4, and is for storing the object categorizing file. The object playing unit 5, which may be implemented by a multimedia playing unit but not limited thereto, is for playing the first object 21. The object selecting unit 6 is coupled to the object playing unit 5, the object database 2 and the object categorizing database 3, and is for selecting the target object 22 from the object database 2 according to the first object 21 currently played by the object playing unit 5 as well as with reference to the object categorizing file. The object playing unit 5 simultaneously plays the target object 22 and the first object 21.

Referring to FIG. 1, to use the apparatus 1 for playing mapped objects, the object playing unit 5 plays the user-selected first object 21, e.g., a picture file. Supposing that the picture file, i.e., the first object 21, is a digital photo taken during a trip to Japan, the categorizing unit 4 then categorizes the first object 21 as a Japan-related object and establishes an object categorizing file to be stored in the object categorizing database 3. The object categorizing file records the file name and category of the first object 21. The categorization rule of the categorizing unit 4 may be based on the file name, the file size or the established time of the first object 21. For example, the file name of the first object 21 may be “Japan_{—}001,” based on which the categorizing unit 4 categorizes the first object 21 as “Travel_Japan”. Similarly, the categorizing unit 4 can also categorize the first object 21 according to its established time. For instance, the first object 21 was established on Mar. 14, 2006, and the categorizing unit 4 then categorizes the first object 21 to the category of “Year_{—}2006.” Similar methods can be easily applied but shall not be further described for brevity.

Suppose that the objects also categorized as “Travel_Japan” in the categorizing database 2 further comprise the target object 22, e.g., a music file, and the categorizing information thereof is also recorded in the object categorizing file stored in the object categorizing database 3. When the object playing unit 5 plays the first object 21, the object selecting unit 6 selects the target object 22 from the same category as the first object 21 based upon the first object 21 currently played by the object playing unit 5 as well as with reference to the object categorizing file. The target object 22 is then transmitted to the object playing unit 5, whereby the object playing unit 5 simultaneously plays the first object 21 and the target object 22 of the same category.

The foregoing example is only one of the preferred embodiments of the present invention. As another example, to listen to music, the apparatus 1 for playing mapped objects according to the invention can also search for appropriate picture files or the multimedia file combinations to be played simultaneously. Alternatively, the apparatus 1 for playing mapped objects can also simultaneously play any user-specified multimedia file combinations as desired.

Further, to satisfy personal preferences on particular multimedia file combinations, the apparatus 1 for playing mapped objects disclosed in another embodiment according to the present invention further comprises a user behavior database 8. The user behavior database 8 is coupled to the categorizing unit 4, and is for storing an object selecting record. The categorizing unit 4 further generates the object categorizing file according to the object selecting record, which is generated according to the time or the number of times that the first object 21 and the target object 22 are played simultaneously. Thus, when certain multimedia files are selected, the apparatus 1 for playing mapped objects plays the mapped multimedia files according to the corresponding object selecting record of the first object 21 and the target object 22 previously selected. Thereby, to satisfy personal preferences on particular multimedia file combinations, when the first object 21 is selected, the apparatus 1 for playing mapped objects according to the invention can quickly select the desired target object 22 to be played simultaneously according to the object selecting record.

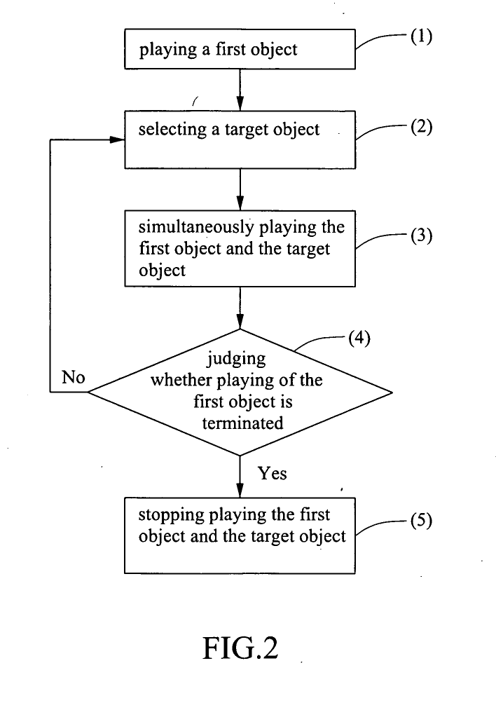

Further referring to FIG. 2, to use the apparatus 1 for playing mapped objects disclosed by the present invention, for instance, to select a music file of American rock music to listen to, the user usually views photos taken during a trip to the United States at the same time when listening to the music file. Meanwhile, the object selecting unit 6, based on an established time or the number of times that the music file (i.e., the first object 21) and the photo (i.e., the target object 22) are played simultaneously, establishes the object selecting record, which shall be stored in the user behavior database 8. The categorizing unit 4 then establishes an object categorizing file based upon the object selecting record. For example, having checked the time and the number of times that the first object 21 and the target object 22 are played simultaneously, the categorizing unit 4 establishes the object categorizing file when a total time or a total number of times that the first object 21 and the target object 22 are played simultaneously exceeds a predetermined value, e.g., 10 hours and 20 times. Such object categorizing file established by the categorizing unit 4 records a relationship between the first object 21 and the target object 22. When the US rock music (i.e., the first object 21) is played again without selecting a specific photo to be viewed, the object selecting unit 6 shall select the photo (i.e., the target object 22) from the object database 2 based upon the rock music played by the object playing unit 5 as well as with reference to the object categorizing file. More specifically, the object playing unit 5 plays the photo (i.e., the target object 22) simultaneously when playing the American rock music (i.e., the first object 21). The music in conjunction with the photo is used as an example used in the above embodiment. In another example, the apparatus 1 for playing mapped objects may also search for appropriate music to be played simultaneously while viewing a picture, or play the foregoing multimedia file combinations simultaneously.

The aforementioned categorizing unit 4 further categorizes objects in the object database 2 according to a categorization rule to enhance the object categorizing file. For example, the categorizing unit 4 categorizes the objects according to the file name, file size, established time, or established date of the first object 21. Similar modifications, without departing from the spirit and scope of the invention, can be made by a person having ordinary skills in the art, and shall not be unnecessarily further described.

FIG. 2 relates to a flow chart of the method for playing mapped objects according to the present invention. The method comprises steps of: (1) playing a first object, e.g., music, a photo, a video or a multimedia file; (2) selecting a target object, e.g., music, a photo, a video or a multimedia file, corresponding to a category of the first object from an object database according to the first object and an object categorizing file; and simultaneously playing the target object while the first object is played, wherein the object categorizing file is generated either by categorizing the first object according to at least one categorization rule, or by the time duration or the number of times that the first object and the target object are played simultaneously, and the categorization rule is based on a file name or an established time of the first object; (3) simultaneously playing the first object and the target object; (4) judging whether playing of the first object is terminated (e.g., judging whether playing of the first object is terminated voluntarily or by the user), if affirmative, proceeding (5), otherwise performing (2); and (5) stopping playing the first object and the target object.

Thus, when the first object 21 is selected to be played, the corresponding target object 22 can be selected from the object categorizing database 2, so that the object playing unit 5 plays the first object 21 and the target object 22 simultaneously, thereby playing a plurality of multimedia objects of a same category at the same time.

As discussed in the foregoing description, the present invention provides the apparatus 1 for playing mapped objects and the method thereof. Using the apparatus 1 for playing mapped objects according to the invention, when the first object 21, e.g., a current multimedia file including images and sounds, is selected to be played, the target object 22 of a corresponding category is also selected from the object categorizing database 2, e.g., multimedia files of the corresponding videos or audios, so that the object playing unit 5 plays the first object 21 and the target object 22 simultaneously, thereby playing a plurality of multimedia objects of a same category at the same time.

It will be appreciated to those skilled in the art having the benefit of this disclosure that this invention is believed to provide a practical implementation of an apparatus or method. Further modifications and alternative embodiments of various aspects of the invention will be apparent to those skilled persons in view of this description. The specification and drawings are to be regarded in an illustrative rather than a restrictive sense.

What is claimed is:

1. An apparatus for playing mapped objects, comprising:
an object database, having a current object and a target object;
a categorizing unit, coupled to the object database, for categorizing the current object according to at least one categorization rule, and generating an object categorization file;
an object categorizing database, coupled to the categorizing unit, for storing the object categorizing file;
an object playing unit, for playing the current object; and
an object selecting unit, coupled to the object playing unit, the object database and the object categorizing database, for selecting the target object from the object database according to the current object currently played by the object playing unit and the object categorization file;
wherein, the object playing unit simultaneously plays the target object and the current object.

2. The apparatus of claim 1, further comprising:
a user behavior database, coupled to the categorizing unit, for storing an object selecting record;
wherein, the categorizing unit generates the object categorizing file according to the object selecting record.

3. The apparatus of claim 2, wherein the object selecting record is generated according to an established time or the number of times that the current object and the target object are played simultaneously.

4. The apparatus of claim 3, wherein the current object and the target object are music, photos, videos, or multimedia files.

5. The apparatus of claim 1, wherein the categorization rule is based on a file name or an established time of the current object.

6. The apparatus of claim 1, wherein the object playing unit is a multimedia playing unit.

7. An apparatus for playing mapped objects, comprising:
an object database, having a current object and a target object;
a user behavior database, for storing an object selecting record;
a categorizing unit, coupled to the user behavior database, for generating an object categorizing file according to the object selecting record;
an object categorizing database, coupled to the categorizing unit, for storing the object categorizing file;
an object playing unit, for playing the current object; and
an object selecting unit, coupled to the object playing unit, the object database and the object categorizing database, for selecting the target object from the object database according to the current object currently played by the object playing unit and the object categorizing file;
wherein, the object playing unit simultaneously plays the target object and the current object.

8. The apparatus of claim 7, wherein the object selecting record is generated according to an established time or the number of times that the current object and the target object are played simultaneously.

9. The apparatus of claim 7, wherein the categorizing unit generates the object categorizing file according to at least one categorization rule.

10. The apparatus of claim 9, wherein the categorization rule is categorized according to a file name or an established time of the current object.

11. The apparatus of claim 7, wherein the current object and the target object are music, photos, videos, or multimedia files.

12. The apparatus of claim 7, wherein the object playing unit is a multimedia playing unit.

13. A method for playing mapped objects, comprising steps of:
(1) playing a current object;
(2) selecting a target object from an object database according to the current object and an object categorizing file; and
(3) simultaneously playing the target object and the current object.

14. The method of claim 13, wherein the object categorizing file is generated by categorizing the current object according to at least one categorization rule.

15. The method of claim 14, wherein the categorization rule is based on a file name or an established time of the current object.

16. The method of claim 13, wherein the object categorizing file is established according to an established time or the number of times that the current object and the target object are played simultaneously.

17. The method of claim 13, further comprising steps of:
(4) judging whether playing of the current object is terminated, if affirmative, proceeding step (5), otherwise performing step (2); and
(5) stopping playing the current object and the target object.

18. The method of claim 13, wherein the current object and the target object are music, photos, videos, and multimedia files.
